(19) United States
(12) Patent Application Publication
(10) Pub. No.: US 2021/0313098 A1
(43) Pub. Date: Oct. 7, 2021

(54) MAGNET AND METHOD FOR PRODUCING MAGNET

(71) Applicant: CANON KABUSHIKI KAISHA, Tokyo (JP)

(72) Inventors: Daisuke Sasaguri, Kanagawa (JP); Masanobu Ootsuka, Tokyo (JP); Naoki Nishimura, Tokyo (JP)

(21) Appl. No.: 17/344,676

(22) Filed: Jun. 10, 2021

Related U.S. Application Data
(63) Continuation of application No. PCT/JP2019/049615, filed on Dec. 18, 2019.

(30) Foreign Application Priority Data
Dec. 27, 2018 (JP) 2018-245136

(51) Int. Cl. H01F 1/059; H01F 1/34; B22F 1/00; B22F 9/04; C22C 38/00; C22C 33/02; H01F 41/02

(52) U.S. Cl. CPC H01F 1/059; H01F 1/344; B22F 1/0018; B22F 9/04; B82Y 25/00; C22C 38/005; C22C 33/02; H01F 41/0293; C22C 38/001

(57) ABSTRACT

A magnet includes hard magnetic particles containing a rare-earth metal, and a soft magnetic material interposed between the hard magnetic particles to bind together the hard magnetic particles.

### CROSS-REFERENCE TO RELATED APPLICATIONS

This application is a Continuation of International Patent Application No. PCT/JP2019/049615, filed Dec. 18, 2019, which claims the benefit of Japanese Patent Application No. 2018-245136, filed Dec. 27, 2018, both of which are hereby incorporated by reference herein in their entirety.

### TECHNICAL FIELD

The present invention relates to a magnet and a method for producing a magnet.

### BACKGROUND ART

As magnets having high residual magnetic flux density (residual magnetization) Br and high coercive force Hc, neodymium magnets are known. Such known neodymium magnets include, in addition to sintered magnets provided by sintering treatment, neodymium bonded magnets provided by molding together Nd—Fe—B-based magnetic particles (neodymium-iron-boron-based magnetic particles) with a binder such as resin therebetween. The Nd—Fe—B-based magnetic particles include, as a component, Nd₂Fe₁₄B. Stated another way, such a neodymium magnet is one of rare-earth-iron-based magnets containing a compound of a rare-earth element and iron as a main phase.

As rare-earth-iron-based magnets other than neodymium magnets, Sm—Fe—N-based magnets containing a Sm—Fe—N-based compound as a main phase (samarium-iron-nitrogen-based magnets) are known. The Sm—Fe—N-based alloy includes Sm₂Fe₁₇N₃.

A technique of improving the practicability of a magnet including magnetic particles has been developed: a soft magnetic phase having high residual magnetization Br and a hard magnetic phase having high coercive force Hc are made to coexist in fine sizes of several tens of nanometers or less such that exchange interaction occurs, to thereby provide a nanocomposite magnetic material in which the two phases are magnetically coupled. Japanese Patent Laid-Open No. 2007-39794 discloses a nanocomposite magnet provided by performing a nitrogen plasma treatment to nitride nanoparticles of a SmFe alloy precursor to prepare Sm₂Fe₁₇N₃ alloy nanoparticles having hard magnetism, and by heat-molding a mixture body of Fe particles and the Sm₂Fe₁₇N₃ particles. Japanese Patent Laid-Open No. 2007-39794 discloses that a method for producing a Sm—Fe—N-based magnet includes a step of reducing a Sm complex and an Fe complex that serve as starting materials, to thereby achieve uniformity of the particle sizes of the nanoparticles of a SmFe alloy precursor.

### CITATION LIST

### Patent Literature

PTL 1 Japanese Patent Laid-Open No. 2007-39794

However, some Sm—Fe—N-based composite magnets obtained by the production method described in Japanese Patent Laid-Open No. 2007-39794 have coercive force Hc lower than the coercive force Hc expected from the uniformity of the particle sizes of the hard magnetic phase. From the viewpoint of ensuring the reproducibility of magnetic properties, there has been a demand for further improvement.

### SUMMARY OF INVENTION

Thus, an object of the present invention is to provide a magnet in which exchange interaction of a soft magnetic phase and a hard magnetic phase is ensured with stability, to provide stable magnetic properties.

A magnet according to a first of the present invention includes hard magnetic particles containing a rare-earth metal, and a soft magnetic material interposed between the hard magnetic particles to bind together the hard magnetic particles.

A method for producing a magnet according to a second of the present invention includes a step of preparing a dispersion liquid including hard magnetic particles having an average particle size of 100 nm or more and soft magnetic particles having a smaller average particle size than the hard magnetic particles; a step of recovering a mixture body including the hard magnetic particles and the soft magnetic particles dispersed in the dispersion liquid; a step of molding the recovered mixture body; and a step of sintering the molded mixture body.

Further features of the present invention will become apparent from the following description of exemplary embodiments with reference to the attached drawings.

### BRIEF DESCRIPTION OF DRAWINGS

FIG. 1 schematically illustrates the structure of a magnet according to a first embodiment.

FIG. 2A is a flow chart illustrating a method for producing a magnet according to a first embodiment.

FIG. 2B is a flow chart illustrating a method for producing a magnet according to a modification.

FIG. 2C is a flow chart illustrating a method for producing a magnet according to a modification.

FIG. 3 schematically illustrates the structure of a magnet according to a modification of a first embodiment.

FIG. 4 illustrates the appearance of the pellet-shape of a magnet according to Example 1.

### DESCRIPTION OF EMBODIMENTS

Hereinafter, embodiments according to the present invention will be described. Note that the present invention is not limited to the following embodiments, and the following embodiments that are, for example, appropriately changed or improved without departing from the spirit and scope of the present invention on the basis of ordinary knowledge of those skilled in the art also fall within the scope of the present invention.

### First Embodiment

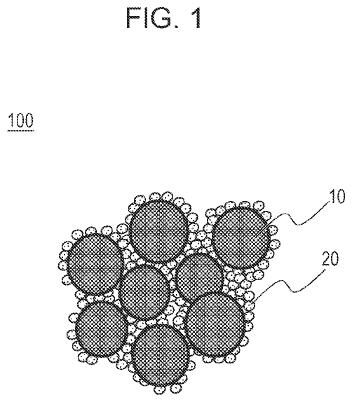

Hereinafter, the configuration of a magnet 100 according to this embodiment will be described with reference to FIG. 1. As illustrated in FIG. 1, the magnet 100 according to this embodiment includes hard magnetic particles 10 containing a rare-earth metal, and a soft magnetic material 20 interposed between the hard magnetic particles 10 to bind together the hard magnetic particles 10. Stated another way, the soft magnetic material 20 according to this embodiment is a binder matrix that binds together the hard magnetic particles. In the Description of the present application, the soft magnetism encompasses examples having magnetic properties having high residual magnetization Br, and the hard magnetism encompasses examples having magnetic properties having high coercive force Hc. Thus, the hard magnetic particles encompass magnetic particles having a hard magnetic phase, and the soft magnetic material encompasses materials having a soft magnetic phase and having morphologies of a particle form and a continuous-body form. Incidentally, most of magnetic materials have a trade-off relationship between the properties that are residual magnetization Br and coercive force Hc.

The hard magnetic particles 10 according to this embodiment are disposed so as to have an average inter-particle distance of 100 nm or less. This is because, when the hard magnetic particles 10 are excessively separated from each other, the effect due to gaps or the soft magnetic material 20 between the hard magnetic particles 10 becomes predominant to limit the coercive force Hc. The inter-particle distance Dhp can be determined in consideration of the average particle size Φhp of the hard magnetic particles 10 and the interposition distance Dsi of the soft magnetic material 20 interposed between the particles so as to satisfy General formulas 1 and 2. Note that the inter-particle distance D in the Description of the present application is used to mean the distance between the centers of gravity of particles.

0≤Dhp−Φhp≤Dsi (Formula 1)

Dhp−Dsi≥0 (Formula 2)

In General formulas 1 and 2 above, in order to exert exchange interaction between the soft magnetic phase (soft magnetic material 20) and the hard magnetic phase (hard magnetic particles 10), the hard magnetic particles preferably have an average particle size of 100 nm or more. More preferably, the hard magnetic particles preferably have an average particle size of 150 nm or more. For the hard magnetic particles, the size of the hard magnetic particles that can be synthesized as a single phase, in other words, the process for the hard magnetic particles, can define the upper limit of the average particle size; such an upper limit is said to be about 50 μm.

Similarly, in the General formulas 1 and 2 above, in order to exert exchange interaction between the soft magnetic material 20 and the hard magnetic particles 10, the hard magnetic particles 10 preferably have an average inter-particle distance of 100 nm or less. In General formulas 1 and 2 above, in order to exert exchange interaction between the soft magnetic material 20 and the hard magnetic particles 10, the interposition distance Dsi of the soft magnetic material 20 interposed between the hard magnetic particles 10 is preferably 30 nm or less.

Similarly, in General formulas 1 and 2 above, in order to exert exchange interaction between the soft magnetic material 20 and the hard magnetic particles 10, the volume ratio of the soft magnetic material 20 to the magnet 100 is preferably 50% or less. More preferably, the volume ratio of the soft magnetic material 20 to the magnet 100 is 10% or more and 30% or less.

The hard magnetic particles 10 include particles of a nitride of an alloy including Sm and Fe, and can be referred to as, using a hyphen symbol (-) intended not to describe the composition ratio, Sm—Fe—N particles. The Sm—Fe—N particles have magnetic properties of high magnetization Br and high coercive force Hc, but have a relatively low thermal decomposition temperature of 500° C., which places thermal limitations on production of sintered magnets without the binder matrix.

Structure

The magnet 100 according to this embodiment has a structure in which the soft magnetic material 20 binds together the hard magnetic particles 10. The magnet 100 preferably has a structure in which the soft magnetic material 20 binds together the hard magnetic particles 10 such that the soft magnetic material 20 and the hard magnetic particles 10 are magnetically coupled by the exchange coupling effect.

Thus, when the distance between the soft magnetic material 20 and the hard magnetic particles 10 where the exchange coupling effect is exerted (hereafter, referred to as “exchange coupling distance”) is denoted by a, the average distance d between two adjacent hard magnetic particles in the magnet 100 preferably satisfies d≤2a. In other words, the average distance between two adjacent hard magnetic particles is preferably two times or less the exchange coupling distance a.

When the soft magnetic material 20 includes α-Fe, the average distance d (corresponding to Dhp above) between two adjacent hard magnetic particles 10 is desirably shorter than the exchange coupling distance a, desirably 100 nm or less, preferably 50 nm or less, more preferably 30 nm or less.

When the volume ratio of the soft magnetic material 20 to the magnet 100 is excessively high, some regions have long distances between hard magnetic particles, which results in an increase in the ratio of the soft magnetic material 20 that is not subjected to the exchange coupling effect. For this reason, the volume ratio of the soft magnetic material 20 to the whole is preferably 50% or less, more preferably 30% or less.

The magnet 100 has a fine composite structure in which Sm—Fe—N particles having a hard magnetic phase are dispersed on the order of several tens of nanometers or less, and, in the gaps between the Sm—Fe—N particles, the soft magnetic material 20 having a soft magnetic phase is present. Because of such a composite structure, the soft magnetic material 20 exerts not only the binding effect, but also the exchange coupling effect on the hard magnetic particles 10. When the exchange coupling effect is exerted between the soft magnetic material 20 and the hard magnetic particles 10, upon application of a reversal magnetic field to the magnet 100, magnetization of the hard magnetic particles 10 under exchange coupling hinders magnetization reversal of the soft magnetic material 20. At this time, the magnetization curve behaves, because of the exchange coupling effect, as if the soft magnetic material 20 and the hard magnetic particles 10 were a single-phase magnet. This provides a magnetization curve having both of the high magnetization (residual magnetic flux density) Br of the soft magnetic material 20 and the high coercive force Hc of the hard magnetic particles 10. As a result, the magnet 100 achieves high energy product (BH)ₘₐₓ. Incidentally, such magnets in which the exchange coupling effect is exerted between the soft magnetic phase (20) and the hard magnetic phase (10) are known as nanocomposite magnets or exchange spring magnets.

Soft Magnetic Material

The soft magnetic material 20 includes iron or an iron alloy. The soft magnetic material 20 preferably includes α-Fe (α-iron) or an FeM alloy where M represents at least one element selected from the group consisting of Co, Ni, Al, Ga, and Si, and the composition proportions of the elements in the FeM alloy can be appropriately selected. The soft magnetic material 20 more preferably includes α-Fe, particularly preferably includes α-Fe as the main phase. Incidentally, the iron or iron alloy included in the soft magnetic material 20 does not necessarily have crystallinity.

The soft magnetic material 20 is preferably a material that has a higher saturation magnetic flux density Ms than the hard magnetic particles 10. The soft magnetic material 20 preferably has a saturation magnetic flux density Ms of 50 emu/g or higher, more preferably 100 emu/g or higher. In order to exert the binding effect in low-temperature processes, the particle sizes of the soft magnetic material 20, namely, the average particle size is preferably less than 50 nm, more preferably 30 nm or less. In such a case of reducing the particle sizes of the soft magnetic material 20 so as to have an average particle size of 50 nm or less, the specific surface area is limited, so that the effect of causing a decrease in the effective softening temperature is expected.

Hard Magnetic Particles

The hard magnetic particles 10 are a material having a higher coercive force Hc than the soft magnetic material 20. The coercive force of the hard magnetic particles is not particularly limited, and is preferably 1000 Oe or higher, more preferably 5000 Oe or higher.

The hard magnetic particles 10 can be a nitride or boride including a rare-earth element and iron. The hard magnetic particles 10 are preferably Sm—Fe—N particles from the viewpoint of high Curie temperature. The Sm—Fe—N particles are a magnetic material that undergoes less degradation of magnetic properties during use in a temperature range of less than 500° C. where thermal decomposition does not occur. In addition, even when the Sm—Fe—N particles are used alone not in the form of a composite material, they are a material that has both of a high coercive force Hc and a high magnetization Br, so that the resultant magnet 100 is a magnetic material having a high energy product (BH)ₘₐₓ. The Sm—Fe—N particles are namely a nitride of a samarium-iron alloy.

For the particle sizes of the hard magnetic particles 10, which have a melting point or softening point higher than the temperature at which the soft magnetic material 20 starts to melt and soften, the hard magnetic particles 10 have particle sizes larger than the interposition distance Dsi of the soft magnetic material 20.

When the hard magnetic particles 10 have particle sizes similar to the average particle size Φsp of the soft magnetic material 20 combined with the hard magnetic particles 10, the hard magnetic particles 10 have an increased surface area in the magnet 100, so that the volume ratio of the soft magnetic material 20 for binding together needs to be increased. This results in the necessity of accurate control of the distance between the hard magnetic particles for exerting exchange coupling, and a cause of large variations in the magnetic properties. For this reason, the hard magnetic particles preferably have sizes of 100 nm or more, more preferably 500 nm or more. The upper limit of the particle sizes is not particularly defined; from the viewpoint of the sizes of particles formed by ordinary synthesis processes, maximum particles employed can have sizes of about several tens of micrometers. Note that “the hard magnetic particles 10 have particle sizes similar to the average particle size Φsp of the soft magnetic material 20 combined with the hard magnetic particles 10” is used to mean that, in the Description of the present application, the sizes are 0.5 times or more and 2 times or less ϕsp.

Method for Producing Hard Magnetic Particles

In the case of synthesizing Sm—Fe—N particles employed as the hard magnetic particles 10, the starting materials can be oxide of Sm and iron oxide. Alternatively, for the starting materials in the case of synthesizing Sm—Fe—N particles, another process can also be employed: Sm and iron are dissolved in acid and a precipitation reaction due to insoluble salt such as hydroxide is used to synthesize the raw material.

To a process of reducing a raw material mixture obtained by mixing the above-described starting materials of samarium and iron in a predetermined ratio, a well-known reduction technique can be employed. In such a reduction process, the material other than the rare-earth element can be reduced using a reducing gas such as hydrogen while, for the rare-earth element, the reduction diffusion process of using metallic Ca as a reducing agent can be applied. The reduction diffusion process is employed because the rare-earth element is less likely to be reduced by hydrogen.

Subsequently, the alloy particles obtained by the reduction diffusion process are subjected to a heating treatment for nitriding. The alloy particles include, for example, oxide of Ca used in the reaction, Ca nitride, and unreacted metallic Ca; the alloy particles are immersed in water, so that the alloy-particle mass disintegrates, and the excess Ca component reacts with water to turn into hydroxide. Subsequently, a rinsing step is performed to remove impurities such as hydroxides. Subsequently, the resultant is dried to provide usable hard magnetic particles 10.

Method for Producing Magnet

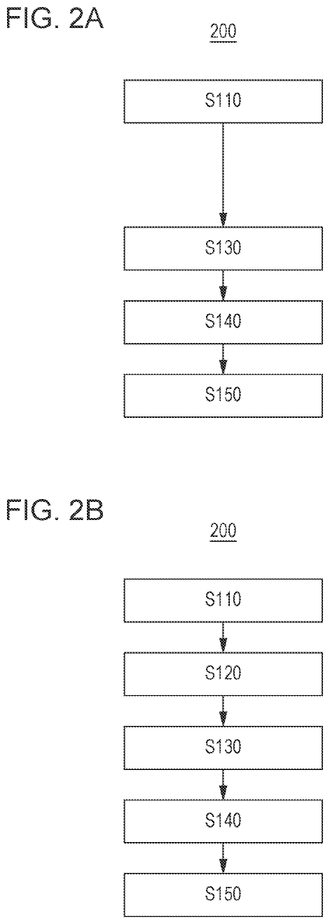

Hereinafter, a method for producing the magnet 100 according to this embodiment will be described with reference to FIG. 2A. The magnet 100 according to this embodiment can be produced by a production method 200 illustrated in FIG. 2A.

Specifically, the production method 200 includes Step S110 of preparing a dispersion liquid DL110 including the hard magnetic particles 10 having an average particle size of 100 nm or more, and soft magnetic particles SP having a smaller average particle size than the hard magnetic particles 10. The production method 200 further includes Step S130 of recovering a mixture body CM including the hard magnetic particles 10 and the soft magnetic particles SP dispersed in the dispersion liquid DL110, Step S140 of molding the recovered mixture body CM, and Step S150 of sintering the molded mixture body CM.

In Step S110 of preparing the dispersion liquid DL110, as the hard magnetic particles 10 having an average particle size of 100 nm or more, Sm—Fe—N particles are employed; as the soft magnetic particles SP having a smaller average particle size than the hard magnetic particles 10, α-Fe particles are employed. The stability of the dispersion liquid DL110 is achieved by controlling the ζ-potential of the liquid system using control parameters such as pH of the solvent and the surface energy of the Sm—Fe—N particles and the α-Fe particles.

Step S130 of recovering the mixture body CM including the hard magnetic particles 10 and the soft magnetic particles SP dispersed in the dispersion liquid DL110 can be performed by drying the dispersion liquid DL110. Step S140 of molding the recovered mixture body CM and Step S150 of sintering the molded mixture body CM can be sequentially performed as illustrated in FIGS. 2A to 2C, or simultaneously performed. These Steps S110, S130, S140, and S150 are performed to thereby provide the magnet 100 (nanocomposite magnetic material) in which the phenomenon of lowering of the melting point of the soft magnetic particles is used to bind together Sm—Fe—N particles with the soft magnetic particles interposed therebetween. The structure in which the soft magnetic material 20 (soft magnetic phase) is interposed between the Sm—Fe—N particles is formed, to thereby provide a nanocomposite magnetic material including Sm—Fe—N particles uniformly dispersed and bound with strong binding forces.

Hereinafter, a production method for producing the magnet 100 according to the first embodiment will be described.

[1] Step S110 of preparing dispersion liquid DL110 including hard magnetic particles 10 and soft magnetic particles SP

This Step S110 is a step of dispersing the hard magnetic particles 10 in a solution in which a metal material serving as the raw material for the soft magnetic material 20 is ionized and dissolved.

This step includes a sub-step of dissolving the raw material including iron or an iron alloy and used for the soft magnetic material 20, and a sub-step of dispersing, in the resultant solution, particles including the hard magnetic particles 10. The mixing ratio (volume ratio) of the soft magnetic material 20 and the hard magnetic particles 10 can be selected from a range in which the exchange coupling effect between the soft magnetic phase and the hard magnetic phase is exerted, and can be 50% or less.

As the starting material for the soft magnetic material 20, an appropriate material can be selected from chlorides, sulfates, and the like. When the soft magnetic material 20 is α-Fe, an optimal material can be appropriately selected from, for example, iron(II) chloride, iron(III) chloride, iron(II)sulfate, iron(III) sulfate, and hydrates of the foregoing. Alternatively, the mixed solution can be provided by individually preparing a solution in which the raw material for the soft magnetic material 20 is dissolved and a dispersion liquid in which particles of the hard magnetic particles 10 are dispersed, and mixing these together.

[2] Step of Precipitating Precursor Particles of Soft Magnetic Material 20

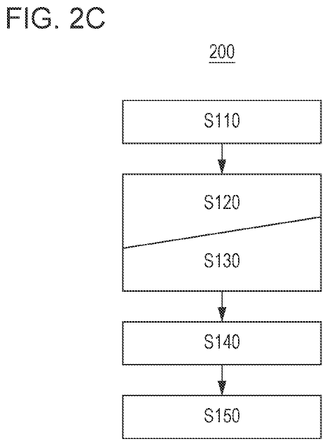

This step is a step performed as needed. As illustrated in FIG. 3, when the magnet 100 does not contain a particulate soft magnetic material but contains a continuous-body soft magnetic material 20, this step can be skipped. This step can also be considered as a sub-step of Step S130 of recovering the mixture body CM. Stated another way, the embodiment illustrated in FIG. 3 is a modification of the first embodiment.

The step is a step of precipitating, from the dispersion liquid prepared in Step S110, soft magnetic particles containing iron and serving as precursor particles of the soft magnetic material 20. In this step, during precipitation of the precursor particles of the soft magnetic material 20, the hard magnetic particles 10 are dispersed in the dispersion liquid, which provides composite particles in which the precursor particles and the hard magnetic particles 10 are uniformly mixed.

For the precursor particles, precipitation conditions can be adjusted to change the composition of the particles or the particle sizes. For example, to a dispersion liquid in which iron(II) chloride, iron(III) chloride, iron(III) nitrate, and iron(II) bromide are dissolved, a reducing agent is added, to thereby achieve precipitation of α-Fe particles from iron ions. The reducing agent is preferably hydrido reducing agents, more preferably sodium tetrahydroborate (NaBH₄).

[3] Step S130 of Recovering, from Dispersion Liquid DL110, Mixture Body CM Including Hard Magnetic Particles 10 and Soft Magnetic Particles SP

This step is a step of recovering, in the solvent, the mixture body CM including hard magnetic particles and soft magnetic particles. The mixture body CM in the dispersion liquid naturally sediments with time, and hence can be recovered by removing the supernatant solvent or can also be recovered by performing centrifugation to achieve sedimentation in a short time.

As illustrated in FIG. 2C, an example in which the period of performing Step S130 of recovering the mixture body CM overlaps the period of performing Step S120 of applying a magnetic field is included as a modification of this embodiment. Stated another way, Recovery step S130 of recovering the mixture body CM according to this modification includes a sub-step of using magnetic-field application means to collect the mixture body CM. Step S130 and Step S120 of applying, from the outside of the container containing the dispersion liquid, a magnetic field are performed in combination to thereby accelerate sedimentation of the mixture body CM. As means for applying, from the outside, a magnetic field to the container containing the dispersion liquid, for example, a magnetic field application apparatus using Lorentz force or a permanent magnet can be employed. To Step S130 of recovering the mixture body CM, a sub-step of providing the effect of localizing and collecting the mixture body, and, for example, transmitting ultrasonic waves into the liquid to cause re-dispersion can also be added. Such a combination of localization and dispersion can provide improved dispersion properties within the recovered mixture body CM.

In Step S120 of applying a magnetic field, in the mixture body CM, the hard magnetic particles 10 have residual magnetization even after the magnetic field is no longer applied. Thus, the soft magnetic material 20 (soft magnetic particles) around the hard magnetic particles 10 are attracted by the magnetic field due to the hard magnetic particles 10, to thereby surround and be adsorbed onto the hard magnetic particles 10.

[4] Step S140 of Molding Recovered Mixture Body CM and Step S150 of Sintering Molded Mixture Body CM

These Steps S140 and S150 are steps of molding and firing composite particles of the precursor particles of the soft magnetic material 20 and the hard magnetic particles, to form the magnet 100.

For such composite magnetic particles 100, as illustrated in FIGS. 2A to 2C, the compression-molding may be followed by the heating treatment, or the compression-molding and the heating treatment may be simultaneously performed.

The heating treatment is preferably performed under an inert gas atmosphere, under a reducing atmosphere, or under a vacuum from the viewpoint of lessening oxidation of the soft magnetic material 20. In addition, in this step, a magnetic field can be applied during the compression-molding to align the easy magnetization axes of the hard magnetic particles 10. Molding with the hard magnetic particles 10 having easy magnetization axes being aligned provides an anisotropic magnet. The hard magnetic particles 10 preferably have easy magnetization axes within a distribution angle of 20° or less, more preferably within a distribution angle of 10° or less.

Magnet

The magnet 100 according to this embodiment can be provided as a nanocomposite magnet. The nanocomposite magnet according to this embodiment is a sintered magnet containing a soft magnetic material and a hard magnetic material, wherein the hard magnetic material is formed of composite nitride particles including Sm and Fe, and the soft magnetic material includes a magnetic material including iron or an iron alloy.

In the sintering step, the magnet is molded into the desired shape, and the obtained molded body is heat-treated under an inert atmosphere or under a vacuum, to provide the sintered magnet. Alternatively, plasma activated sintering (PAS: Plasma Activated Sintering) or spark plasma sintering (SPS: Spark Plasma Sintering) may be performed to sinter the molded body, to thereby provide the sintered magnet. When the molding is performed in a magnetic field, an anisotropic sintered magnet is provided.

Note that, in the Description of the present application, the solid dispersion state in which hard magnetic particles and soft magnetic particles are dispersed may be referred to as a magnetic powder. The magnetic powder is in a state in which exchange interaction is exerted between the hard magnetic phase corresponding to hard magnetic particles and the soft magnetic phase corresponding to soft magnetic particles. A state in which exchange interaction is not exerted between the hard magnetic phase and the soft magnetic phase includes a state in which hard magnetic particles are not dispersed with a distance therebetween on the order of particle sizes, and the aggregation mass (secondary particles) of the hard magnetic particles is predominantly present. In the Description of the present application, “predominantly present” means 50% or more in mass %. The state in which exchange interaction is not exerted between the hard magnetic phase and the soft magnetic phase includes a state in which hard magnetic particles and soft magnetic particles are not subjected to a dispersion treatment, and are simply mixed together. In addition, the state in which exchange interaction is not exerted between the hard magnetic phase and the soft magnetic phase includes a state in which hard magnetic particles alone or soft magnetic particles alone are included.

In the Description of the present application, magnets refer to sintered bodies of composite magnetic materials in which the dispersion state of hard magnetic particles and soft magnetic particles is fixed so as to exert exchange interaction between the hard magnetic particles and the soft magnetic particles, and may also be referred to as composite magnetic materials. Such magnets may be finely dispersed in solvents to form magnetic fluids.

### EXAMPLES

Hereinafter, Examples are used to describe the present invention further in detail; however, the technical scope of the present invention is not limited to the following Examples. Note that “%” used in the following description are all based on mass unless otherwise specified.

### Example 1

Production of Sm—Fe—N Particles

Sm—Fe—N particles including Sm₂Fe₁₇N₃ were produced in the following manner.

Samarium oxide Sm₂O₃ having an average particle size of 1 μm (purity: 99.9%), and iron oxide Fe₂O₃ having an average particle size of 1.1 μm were mixed together using a wet ball mill for 1 hour. Subsequently, as a preliminary reduction step of the iron oxide, the mixed particles provided by mixing using the ball mill were held in a 2% H₂/98% N₂ mixed gas atmosphere at a temperature of 600° C. for 2 hours, to partially reduce the iron oxide into iron.

Subsequently, a raw material A, which was the iron oxide partially reduced to iron, and particulate Ca in an amount of 2 times the oxygen amount of the oxide in the raw material A were mixed together to prepare a mixture body B. This mixture body B was placed into a hermetic container, subjected to evacuation, subsequently, under a stream of gas, heated to 1050° C., and held for 3 hours to perform a reduction diffusion treatment.

Subsequently, after the hermetic container was cooled to room temperature, the hermetic container was evacuated, under a stream of nitrogen gas, heated to 450° C., held in this heating state for 24 hours to perform a nitriding treatment, and subsequently cooled.

Subsequently, the resultant product C was placed into ion-exchanged water and subjected to a stirring treatment. The product C easily disintegrated in ion-exchanged water and turned into powder. Rinsing with ion-exchanged water was repeated several times to obtain the target magnetic material powder as a precipitate. The precipitate was further rinsed in an aqueous acetic acid solution adjusted to pH 4.5, to remove the by-product D. The precipitate E was centrifuged and subjected to exchange to alcohol to provide a centrifuge cake F. The centrifuge cake F was further subjected to a dehydration-drying treatment to provide a magnet powder G. The magnetic powder G obtained in this way was subjected to composition analysis and crystal analysis and was identified as particles including Sm₂Fe₁₇N₃. The obtained magnetic powder G was subjected to observation and image processing using a scanning electron microscope (SEM) and was found to have an average particle size of 2.8 μm. In addition, an MPMS (Magnetic Property Measurement System) from Quantum Design Inc. was used to measure magnetic properties of the obtained magnetic powder G. The obtained measurement results of magnetic properties of the magnetic powder G were a residual magnetization Br of 115.6 emu/g and a coercive force Hc of 14.2 kOe, which has demonstrated the presence of a hard magnetic phase.

Production of Magnet Formed of Magnetic Powder G and α-Fe

Composite particles of the magnetic powder G and α-Fe particles were produced. To a mixed solution of a solution in which iron(II) bromide (FeBr₂) was dissolved and a dispersion liquid in which Sm₂Fe₁₇N₃ particles were dispersed, as a reducing agent, sodium tetrahydroborate (NaBH₄) was added, to precipitate α-Fe. This addition of the reducing agent formed composite particles of α-Fe particles and the magnetic powder G, to produce a magnetic material.

First, 1.1 g of FeBr₂ was weighed, and dissolved in 75 mL of methanol, to provide an iron bromide solution. Subsequently, 1.59 g of Sm₂Fe₁₇N₃ particles were weighed, added to the iron bromide solution, and sufficiently dispersed with an ultrasonic dispersing machine to provide a dispersion liquid. Under such conditions, the volume ratio of α-Fe to the composite particles becomes 15%.

Precipitation of Precursor Particles (Soft Magnetic Particles)

As a reducing agent, 2 g of NaBH₄ was weighed, and dissolved in 20 mL of methanol to prepare a reducing agent solution. Subsequently, to the above-described dispersion liquid under stirring, the reducing agent solution was added dropwise to precipitate α-Fe particles serving as precursor particles to form composite particles also including the hard magnetic powder G. The α-Fe particles in the obtained composite particles were observed for particle sizes using a SEM, and the particles were found to have sizes of about 10 nm.

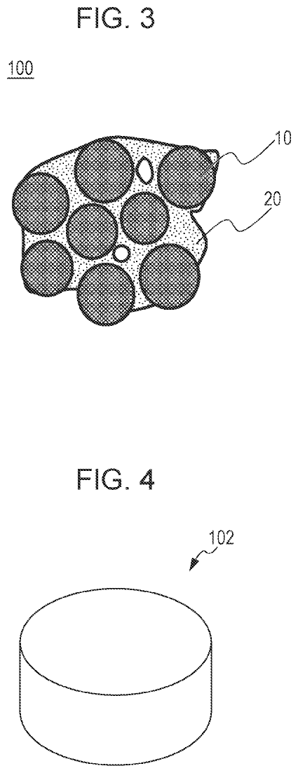

The composite particles (1 g) of the α-Fe particles and the hard magnetic powder G were processed using a compression-molding machine, to produce a molded body. Subsequently, the obtained pellet-shaped molded body was set into an electric furnace, and heat-treated. As the atmosphere gas, nitrogen gas was used, and the gas flow rate was set to 300 sccm. The temperature of the heat treatment was set to 400° C.; holding at 400° C. for 5 hours was performed, and subsequently cooling to room temperature was performed. The appearance of a pellet-shaped magnet 102 produced in this Example is illustrated in FIG. 4.

Structural Analysis of Magnet

The obtained magnet 100 was analyzed for the crystal structure by XRD and, as a result, the diffraction peak of Sm₂Fe₁₇N₃ corresponding to the magnetic powder G, and the diffraction peak corresponding to α-Fe were individually observed. Significant diffraction peaks derived from crystal structures other than Sm₂Fe₁₇N₃ and α-Fe were not observed.

A section of the magnet 100 was observed with a TEM and, as a result, a state in which the α-Fe phase binds together the Sm₂Fe₁₇N₃ particles was observed.

Evaluation of Magnetic Properties of Magnet

The obtained magnet 100 was evaluated for magnetic properties (residual magnetization and coercive force) using the MPMS. The results are described in Table 1.

### Example 2

Sm₂Fe₁₇N₃ particles produced under the same conditions as in Example 1 were used to produce composite particles also including α-Fe. At this time, in order to set the mixing ratio of α-Fe to the whole composite particles to a volume ratio of 30%, 1.1 g of FeBr₂ and 0.65 g of Sm₂Fe₁₇N₃ particles were used and the same process as in Example 1 was performed to precipitate α-Fe.

Subsequently, as in Example 1, a magnet 100 was obtained. The obtained composite magnetic material 100 was analyzed for the crystal structure by XRD; as a result, the diffraction peak of Sm₂Fe₁₇N₃ and the diffraction peak of α-Fe were individually observed while significant diffraction peaks derived from crystal structures other than Sm₂Fe₁₇N₃ and α-Fe were not observed.

In addition, a section of the magnet 100 was observed with a TEM and, as a result, a state in which Sm₂Fe₁₇N₃ particles were bound together with the α-Fe phase therebetween was observed.

Evaluation of Magnetic Properties of Magnet

The obtained magnet 100 was evaluated for magnetic properties (residual magnetization and coercive force) using the MPMS. The results are described in Table 1.

### Example 3

Sm₂Fe₁₇N₃ particles produced under the same conditions as in Example 1 were used to produce composite particles also including α-Fe. At this time, in order to set the mixing ratio of α-Fe to the whole composite particles to a volume ratio of 50%, 1.1 g of FeBr₂ and 0.35 g of Sm₂Fe₁₇N₃ particles were used and the same process as in Example 1 was performed to precipitate α-Fe.

Subsequently, as in Example 1, a magnet 100 was obtained. The obtained composite magnetic material 100 was analyzed for the crystal structure by XRD; as a result, the diffraction peak of Sm₂Fe₁₇N₃ and the diffraction peak of α-Fe were individually observed while significant diffraction peaks derived from crystal structures other than Sm₂Fe₁₇N₃ and α-Fe were not observed.

In addition, a section of the magnet 100 was observed with a TEM and, as a result, a state in which Sm₂Fe₁₇N₃ particles were bound together with the α-Fe phase therebetween was observed.

Evaluation of Magnetic Properties of Magnet

The obtained magnet 100 was evaluated for magnetic properties (residual magnetization and coercive force) using the MPMS. The results are described in Table 1.

### Example 4

As in Example 1, composite particles of α-Fe particles and Sm₂Fe₁₇N₃ particles were obtained.

Subsequently, the composite particles were sintered by a pulse-current heating process (SPS process). The composite magnetic particles (1 g) were charged into a hard-metal die set having an inner diameter of 10 mm, which was then set into a pulse-current sintering apparatus equipped with a compression mechanism (LABOX-650F: manufactured by SinterLand Inc.).

Subsequently, the sintering chamber was set to have a vacuum atmosphere at 2 Pa or less; the magnet powder under application of a compression pressure of 500 MPa was then heated at a heating rate of 50° C./min from room temperature to 200° C., after reaching 200° C., held for 1 minute, and immediately cooled. After completion of cooling to room temperature was confirmed, the pressure was returned to the atmospheric pressure, and the molded body was taken out from the die set.

The obtained magnet 100 was analyzed for the crystal structure by XRD; as a result, the diffraction peak of Sm₂Fe₁₇N₃ and the diffraction peak of α-Fe were individually observed while significant diffraction peaks derived from crystal structures other than Sm₂Fe₁₇N₃ and α-Fe were not observed.

In addition, a section of the magnet 100 was observed with a TEM and, as a result, a state in which Sm₂Fe₁₇N₃ particles were bound together with the α-Fe phase therebetween was observed.

Evaluation of Magnetic Properties of Magnet

The obtained magnet 100 was evaluated for magnetic properties (residual magnetization and coercive force) using the MPMS. The results are described in Table 1.

### Example 5

As in Example 1, composite particles of α-Fe particles and Sm₂Fe₁₇N₃ particles were obtained.

Subsequently, the composite particles were sintered by a pulse-current heating process (SPS process). The composite magnetic particles (1 g) were charged into a non-magnetic die set having sides of 10 mm, which was then set into a magnetic field-molding apparatus, and, under application of, as an external magnetic field, a magnetic field of 30 kOe, compression-molded at a pressure of 100 MPa. Subsequently, this non-magnetic die set was set into a pulse-current sintering apparatus (LABOX-650F: manufactured by SinterLand Inc.).

Subsequently, the sintering chamber was set to have a vacuum atmosphere at 2 Pa or less; the magnet powder under application of a compression pressure of 100 MPa was then heated at a heating rate of 50° C./min from room temperature to 200° C., after reaching 200° C., held for 1 minute, and immediately cooled. After completion of cooling to room temperature was confirmed, the pressure was returned to the atmospheric pressure, and the molded body was taken out from the die set.

The obtained magnet 100 was analyzed for the crystal structure by XRD; as a result, the diffraction peak of Sm₂Fe₁₇N₃ and the diffraction peak of α-Fe were individually observed while significant diffraction peaks derived from crystal structures other than Sm₂Fe₁₇N₃ and α-Fe were not observed.

In addition, a section of the magnet 100 was observed with a TEM and, as a result, a state in which Sm₂Fe₁₇N₃ particles were bound together with the α-Fe phase therebetween was observed.

Evaluation of Magnetic Properties of Magnet

The obtained magnet 100 was evaluated for magnetic properties (residual magnetization and coercive force) using the MPMS. The results are described in Table 1.

### Example 6

As in Example 1, Sm₂Fe₁₇N₃ particles were synthesized. Subsequently, also, as in Example 1, a magnet of Sm₂Fe₁₇N₃ particles and α-Fe was produced.

Subsequently, to the composite magnetic particles dispersed in methanol in the glass beaker, a neodymium magnet was brought near from the outside of the beaker to collect the magnetic particles; subsequently, the neodymium magnet was separated from the glass beaker to let the magnetic particles be dispersed again.

Subsequently, the methanol solution was removed in vacuo, and the resultant magnetic particles (1 g) were charged into a hard-metal die set having an inner diameter of 10 mm, which was then set into a pulse-current sintering apparatus equipped with a compression mechanism (LABOX-650F: manufactured by SinterLand Inc.).

Subsequently, the sintering chamber was set to have a vacuum atmosphere at 2 Pa or less; the magnet powder under application of a compression pressure of 500 MPa was then heated at a heating rate of 50° C./min from room temperature to 200° C., after reaching 200° C., held for 1 minute, and immediately cooled. After completion of cooling to room temperature was confirmed, the pressure was returned to the atmospheric pressure, and the molded body was taken out from the die set.

The obtained magnet 100 was analyzed for the crystal structure by XRD; as a result, the diffraction peak of Sm₂Fe₁₇N₃ and the diffraction peak of α-Fe were individually observed while significant diffraction peaks derived from crystal structures other than Sm₂Fe₁₇N₃ and α-Fe were not observed.

In addition, a section of the magnet 100 was observed with a TEM and, as a result, a state in which the α-Fe phase fused to bind together Sm₂Fe₁₇N₃ particles was observed.

Evaluation of Magnetic Properties of Magnet

The obtained magnet 100 was evaluated for magnetic properties (residual magnetization and coercive force) using the MPMS. The results are described in Table 1.

### Example 7

As in Example 1, Sm₂Fe₁₇N₃ particles were synthesized. Subsequently, composite particles of Sm₂Fe₁₇N₃ particles and α-Fe particles were produced. To a solution in which iron (II) chloride hydrate (FeCl₂.4H₂O) was dissolved, Sm₂Fe₁₇N₃ particles were dispersed; to the resultant dispersion liquid kept in an oil bath at 95° C., as a reducing agent, sodium tetrahydroborate (NaBH₄) was added, to precipitate α-Fe. In this way, reduction was performed to form composite particles of α-Fe particles and Sm₂Fe₁₇N₃ particles to produce a magnetic material.

First, 1 g of FeCl₂.4H₂O was weighed, and dissolved in 75 mL of pure water, to obtain an aqueous iron chloride solution. Subsequently, 1.59 g of Sm₂Fe₁₇N₃ particles was weighed, added to the aqueous iron chloride solution, and sufficiently dispersed with an ultrasonic dispersing machine to provide a dispersion liquid. Under this conditions, the volume ratio of α-Fe to the composite particles becomes 15%. Incidentally, α-Fe was observed with a SEM and was found to have particle sizes of about 50 nm.

Subsequently, the composite particles were sintered by a pulse-current heating process (SPS process). The composite magnetic particles (1 g) were charged into a hard-metal die set having an inner diameter of 10 mm, which was then set into a pulse-current sintering apparatus equipped with a compression mechanism (LABOX-650F: manufactured by SinterLand Inc.).

Subsequently, the sintering chamber was set to have a vacuum atmosphere at 2 Pa or less; the magnet powder under application of a compression pressure of 500 MPa was then heated at a heating rate of 50° C./min from room temperature to 200° C., after reaching 200° C., held for 1 minute, and immediately cooled. After completion of cooling to room temperature was confirmed, the pressure was returned to the atmospheric pressure, and the molded body was taken out from the die set.

The obtained magnet 100 was analyzed for the crystal structure by XRD; as a result, the diffraction peak of Sm₂Fe₁₇N₃ and the diffraction peak of α-Fe were individually observed while significant diffraction peaks derived from crystal structures other than Sm₂Fe₁₇N₃ and α-Fe were not observed.

In addition, a section of the magnet 100 was observed with a TEM and, as a result, a state in which the α-Fe phase fused to bind together Sm₂Fe₁₇N₃ particles was observed.

Evaluation of Magnetic Properties of Magnet

The obtained magnet 100 was evaluated for magnetic properties (residual magnetization and coercive force) using the MPMS. The results are described in Table 1.

### Comparative Example 1

Sm₂Fe₁₇N₃ particles produced under the same conditions as in Example 1 were used to produce composite particles also including α-Fe. At this time, in order to set the mixing ratio of α-Fe to the whole composite particles to a volume ratio of 60%, 1.5 g of FeCl₂.4H₂O and 0.35 g of Sm₂Fe₁₇N₃ particles were used and the same process as in Example 1 was performed to precipitate α-Fe.

Subsequently, as in Example 1, a molded body was produced, and heat-treated to produce a magnet. The obtained magnet was analyzed for the crystal structure by XRD; as a result, the diffraction peak of Sm₂Fe₁₇N₃ and the diffraction peak of α-Fe were individually observed while significant diffraction peaks derived from crystal structures other than Sm₂Fe₁₇N₃ and α-Fe were not observed.

In addition, a section of the magnet 100 was observed with a TEM and, as a result, a state in which Sm₂Fe₁₇N₃ particles were bound together with the α-Fe phase therebetween was observed.

Evaluation of Magnetic Properties of Magnet

The obtained magnet 100 was evaluated for magnetic properties (residual magnetization and coercive force) using the MPMS. The results are described in Table 1.

TABLE 1

| | Synthesis of composite magnetic material | | | | | | | |
|---|---|---|---|---|---|---|---|---|
| | Hard magnetic particles | | Soft magnetic particles | | | | Magnetic properties | |
| | | Particle | | Particle | Volume | | Residual | Coercive |
| | | size | | size | ratio | Magnetic field | magnetization | force |
| | Type | (μm) | Type | (nm) | (%) | alignment | (emu/g) | (kOe) |
| Example 1 | Sm₂Fe₁₇N₃ | 2.8 | α-Fe | 10 | 15 | Not performed | 59 | 11.2 |
| Example 2 | Sm₂Fe₁₇N₃ | 2.8 | α-Fe | 10 | 30 | Not performed | 67 | 10.6 |
| Example 3 | Sm₂Fe₁₇N₃ | 2.8 | α-Fe | 10 | 50 | Not performed | 75 | 7.1 |
| Example 4 | Sm₂Fe₁₇N₃ | 2.8 | α-Fe | 10 | 15 | Not performed | 63 | 11.4 |
| Example 5 | Sm₂Fe₁₇N₃ | 2.8 | α-Fe | 10 | 15 | Performed | 115 | 12.1 |
| Example 6 | Sm₂Fe₁₇N₃ | 2.8 | α-Fe | 10 | 15 | Not performed | 63 | 11.7 |
| Example 7 | Sm₂Fe₁₇N₃ | 2.8 | α-Fe | 50 | 15 | Not performed | 55 | 9.2 |
| Comparative | Sm₂Fe₁₇N₃ | 2.8 | α-Fe | 10 | 60 | Not performed | 13 | 1.2 |
| Example 1 | | | | | | | | |

As described in Table 1, Examples 1 to 7 provided magnetic materials having at least residual magnetizations 4 times or more the residual magnetization of Comparative Example 1, and coercive forces 5 times or more the coercive force of Comparative Example 1. These results have demonstrated that such magnets including nitride magnetic particles containing a rare-earth metal and a soft magnetic material provide magnets having good magnetic properties.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A magnet comprising hard magnetic particles containing a rare-earth metal, and a soft magnetic material interposed between the hard magnetic particles to bind together the hard magnetic particles.

2. The magnet according to claim 1, wherein the hard magnetic particles have an average particle size of 100 nm or more.

3. The magnet according to claim 1, wherein the hard magnetic particles have an average inter-particle distance of 100 nm or less.

4. The magnet according to claim 1, wherein a volume ratio of the soft magnetic material to the magnet is 50% or less.

5. The magnet according to claim 4, wherein the volume ratio of the soft magnetic material to the magnet is 10% or more and 30% or less.

6. The magnet according to claim 1, wherein the soft magnetic material at least includes α-Fe.

7. The magnet according to claim 1, wherein the hard magnetic particles include a nitride of a samarium-iron compound.

8. The magnet according to claim 1, wherein the hard magnetic particles have easy magnetization axes having a distribution angle of 20° or less.

9. The magnet according to claim 8, wherein the hard magnetic particles have easy magnetization axes within a distribution angle of 10° or less.

10. A method for producing a magnet, the method comprising: a step of preparing a dispersion liquid including hard magnetic particles having an average particle size of 100 nm or more and soft magnetic particles having a smaller average particle size than the hard magnetic particles; a step of recovering a mixture body including the hard magnetic particles and the soft magnetic particles dispersed in the dispersion liquid; a step of molding the recovered mixture body; and a step of sintering the molded mixture body.

11. The method for producing a magnet according to claim 10, wherein the hard magnetic particles are a nitride or boride including a rare-earth element and iron.

12. The method for producing a magnet according to claim 11, wherein the rare-earth element includes samarium.

13. The method for producing a magnet according to claim 11, wherein the hard magnetic particles include a nitride of a samarium-iron alloy.

14. The method for producing a magnet according to claim 10, wherein the soft magnetic particles include α-Fe.

15. The method for producing a magnet according to claim 10, further comprising a step of applying a magnetic field to the dispersion liquid.

16. The method for producing a magnet according to claim 15, wherein a period of performing the step of applying a magnetic field to the dispersion liquid overlaps a period of performing the step of recovering the mixture body.

17. The method for producing a magnet according to claim 16, wherein, in the step of applying a magnetic field to the dispersion liquid, magnetic-field application means disposed outside of a container containing the dispersion liquid is used to apply a magnetic field from outside of the dispersion liquid, and
the recovery step of recovering the mixture body includes a step of using the magnetic-field application means to collect the mixture body.
